(19) United States
(12) Patent Application Publication
(10) Pub. No.: US 2022/0161988 A1
(43) Pub. Date: May 26, 2022

(54) SYSTEMS AND METHODS FOR STORAGE OF SANITARY USE ARTICLES

(71) Applicant: Christopher Matysek, Barrington, IL (US)

(72) Inventor: Christopher Matysek, Barrington, IL (US)

(21) Appl. No.: 17/530,417

(22) Filed: Nov. 18, 2021

Related U.S. Application Data
(60) Provisional application No. 63/116,429, filed on Nov. 20, 2020.

(51) Int. Cl. B65D 83/08; B65D 33/24; B65D 85/18; B65D 33/14; B65D 33/00

(52) U.S. Cl. CPC B65D 83/0805; B65D 33/24; B65D 33/004; B65D 33/14; B65D 85/18

(57) ABSTRACT

A holder for the use of sanitary use articles includes a storage pouch including at least front and rear sides, a main access configured to allow the storage pouch to be reversibly interlocked and receive a plurality of gloves within the storage pouch, a dispensing slot disposed on the front side of the storage pouch, wherein the dispensing slot is optionally covered by a reversibly-sealable sanitary strip, and an adhesive patch disposed on the rear side of the storage pouch, wherein the storage pouch is configured to be adhered, by way of the adhesive patch, to an inner portion of a fuel filling compartment door of a vehicle.

### CROSS REFERENCE TO RELATED APPLICATIONS

This application claims priority to and the benefit under 35 USC § 119(e) of U.S. Provisional Patent Application No. 63/116,429 filed on Nov. 20, 2020, under the same application title, the contents of which are incorporated by reference in their entirety as if fully set forth herein.

### STATEMENT REGARDING FEDERALLY SPONSORED RESEARCH OR DEVELOPMENT

None.

### TECHNICAL FIELD

This disclosure relates to systems and methods for storing sanitary use articles. In particular, this disclosure relates to systems and methods for storing sanitary use articles such as gloves within an automobile compartment. Most particularly, this disclosure relates to a pouch for containing gloves, wherein the pouch is configured to be concealably stored within the refueling access enclosure of an automobile.

### BACKGROUND

Surfaces are known to harbor germs such as bacteria and viruses that can contribute to the spread of disease among humans. Certain surfaces are more likely to harbor germs than others by, for example, providing an environment that protects or fosters proliferation of germs. For example, it is generally well-known that dish sponges can carry and foster growth of bacteria by providing a moist environment and nutrients. However, germs can survive on surfaces far less hospitable, such as keyboards, cell phones and remote controls. Each of these types of surfaces, which are often touched by more than one person, can contribute to the spread of disease unless they are continually washed and/or sanitized.

One surface that has been identified as a potential disease-spreading vector is fuel pump handles and buttons. Across the world, fuel pump handles are used by many people to fuel automobiles and other modes of transportation. As is generally known, those wishing to fuel their vehicles use their hands to grab the pump handle, insert the pump nozzle into the fuel port of the automobile, and use their fingers to actuate the pump handle. Thus, a fuel pump handle can come into contact with a person's palm and fingers, typically the pads of the fingers, which are known to be areas of the human body that carry and transmit viruses and bacteria. When fueling is complete, the person typically grabs the handle again to replace it. Subsequently, the next person to fuel their vehicle performs the same process, inviting the spread of germs. In many, if not most cases, fuel handles are not sanitized between uses which contributes to the spread of disease.

In some areas of the world, so-called ‘gas stations’ provide gloves at the pump for users to wear. However, the supply of gloves is not always maintained. Furthermore, germs can be spread by virtue of multiple persons reaching their hand into a box of gloves, thereby defeating their purpose. It is estimated that approximately two million bacteria, virus and other biological organisms can be picked up and remain on a person's palm and fingers with each contact of a non-sterile surface. Lastly, many glove materials—rubber, vinyl, latex, etc. can break down when exposed to natural elements such as rain and sunshine which again reduces their efficacy in reducing the spread of disease.

Accordingly, providing a source of gloves that is known to be of certain quality and readiness, and that is both concealable and protected from the elements for use when fueling a vehicle is an unmet need in the art.

### SUMMARY

In general, a pouch is provided that is configured to retain a plurality of gloves. The pouch is configured to be attached to the door that typically encloses the space around the fuel filler or tank refilling port that is used to fill fuel tanks on many types of automobiles, or inside of the fuel door compartment if there is sufficient space available in proximity to the fuel intake neck or tube.

In one exemplary embodiment, the pouch is configured to accommodate gloves that are folded flat to maximize the number of gloves that can be store therewithin. In another exemplary embodiment, the pouch can be shaped to accommodate the fuel cap when the fuel filler access door is in the closed position. In another exemplary embodiment, the pouch includes an access seam that can be opened to retrieve one or more gloves and closed to store the gloves in a substantially air-tight environment. In another exemplary embodiment, the pouch can include indicia, such as a scannable QR code that a user can use to order additional gloves when the supply in the pouch is depleted or running low, or to order new pouches.

Certain advantages of the systems and methods include the ability to provide a source of sanitary use gloves for use when refueling a vehicle; reduction in transmission of disease by protecting users from unclean, or unsanitary fuel dispensing handles; and providing a simple method of restocking gloves when the supply is depleted or diminished; among others.

Unless otherwise defined, all technical and scientific terms used herein have the same meaning as commonly understood by one of ordinary skill in the art. Although methods and materials similar or equivalent to those described herein can be used in the practice or testing of any described embodiment, suitable methods and materials are described below. In addition, the materials, methods, and examples are illustrative only and not intended to be limiting. In case of conflict with terms used in the art, the present specification, including definitions, will control.

The foregoing summary is illustrative only and is not intended to be in any way limiting. In addition to the illustrative aspects, embodiments, and features described above, further aspects, embodiments, and features will become apparent by reference to the drawings and the following detailed description and claims.

### DESCRIPTION OF DRAWINGS

The present embodiments are illustrated by way of the figures of the accompanying drawings, which may not necessarily be to scale, in which like references indicate similar elements, and in which:

FIG. 1 illustrates a storage pouch for sanitary use articles, and a method of its use, according to one embodiment;

FIG. 2 is a storage pouch for sanitary use articles according to one embodiment, shown adhered to a fuel tank access door of a prior art vehicle;

FIG. 3 shows a front-side view of the storage pouch for sanitary use articles of FIG. 2;

FIG. 4 shows a rear-side view of the storage pouch for sanitary use articles of FIG. 2;

FIG. 5 shows a side view of the storage pouch for sanitary use articles of FIG. 2;

FIG. 6 illustrates a pouch according to a second illustrative embodiment;

FIG. 7 illustrates a pouch according to a third illustrative embodiment;

FIG. 8 illustrates a pouch according to a fourth illustrative embodiment; and

FIG. 9 illustrates a pouch according to a fifth illustrative embodiment and a method for its use.

### DETAILED DESCRIPTION OF ILLUSTRATIVE EMBODIMENTS

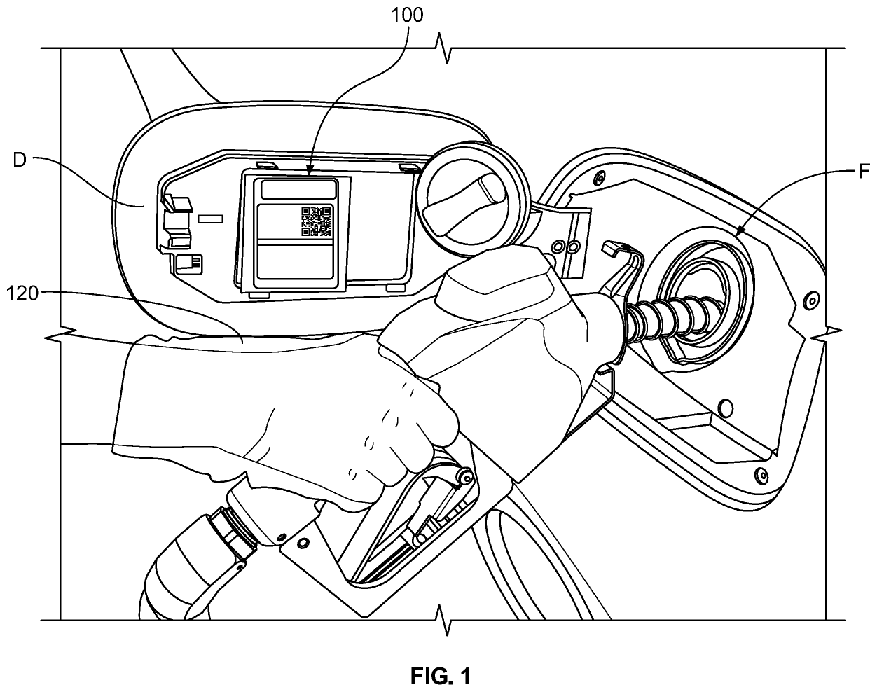

FIG. 1 shows a storage pouch for sanitary use articles (hereinafter ‘pouch’) 100 adhered to an access door D of a fuel filler port F of a vehicle. In this and other embodiments pouch 100 is configured to retain a plurality of protective gloves 120 that are made available to the operator when the access door D is opened. Gloves 120 can protect the operator from communicable diseases such as, but not limited to the Covid-19 virus, and other germs. Gloves 120 additionally protect the operator's hand from dirt and other material that may be present on the fuel pump handle. The gloves 120 can preferably be sanitary use gloves such as, but not limited to latex or non-latex (e.g., latex, nitrile rubber, polyvinyl chloride or neoprene) gloves. In a preferred embodiment, the gloves 120 are relatively thin, so as to maximize the number of gloves that can fit within pouch 100 without significant bulging.

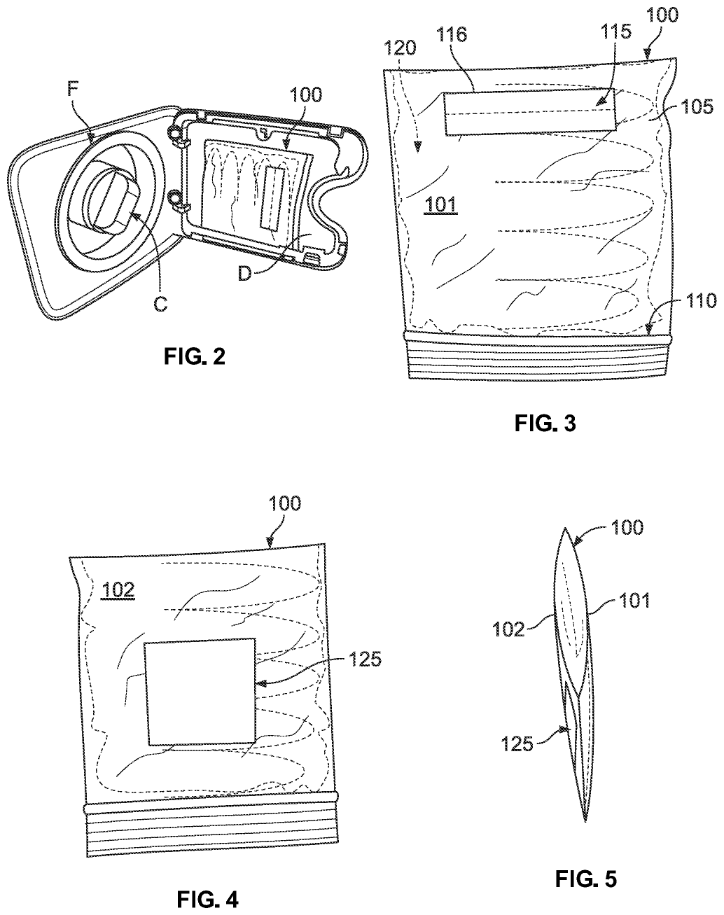

FIGS. 2-4 show an unobstructed view of the pouch 100 in relation to the fuel filler port F of a vehicle. In this and other embodiments, the pouch 100 can be adhered to the inside of access door D such that when the door D is in a closed configuration, the pouch 100 is concealed and confronts, or becomes proximate to cap C, which, in this example, is connected to fuel filler port F.

In this embodiment, pouch 100 includes a front side 101 (FIG. 3) and an opposite rear side 102 (FIG. 4). In this embodiment, the pouch 100 includes a main access 110 that allows the front (101) and rear (102) sides to be reversibly interlocked, e.g., opened and closed. In this example, the main access 110 is similar to the closure system of bags sold under the ZIPLOC® brand.

In this embodiment, the front side 101 includes a dispensing slot 115 illustrated as a dashed line in FIG. 3 to indicate its presence beneath an access strip 116. The dispensing slot 115 is, in this embodiment, a slot within the front side 101 that allows a glove to be removed from the pouch 100. The access strip 116 can be one that initially seals the pouch 100 but can be peeled away to expose the dispensing slot 115 before the pouch 100 is placed into use. In one embodiment, the access strip 116 can be one that is reversibly-removed, so that the access strip 116 can be replaced after a glove is removed from the dispensing slot 115 of the pouch 100.

Referring in particular now to FIG. 4, in this embodiment, the pouch 100 is configured to be adhered to the door D that encloses the fuel filler F of an automobile utilizing an adhering patch 125. In this embodiment, patch 125 includes adhesives on front and rear surfaces, such that it can be adhered to both the pouch 100 and the door D. It should be understood that the patch 125 shown and described in this embodiment is but one of many approaches that can be used to adhere the pouch 100 to the door D, such as by use of hook-and-loop fastening systems, double-sided adhesives, tapes, etc.

Referring now to FIG. 5, a side-view of the pouch 100 is shown to illustrate the overall width of the pouch 100. In many, but not all instances, it can be preferable to maintain the width of the pouch such that it does not interfere with the closure of door D or any ventilation characteristics or features of the gas cap C or fuel port F. In one embodiment, pouch 100 is configured to retain about 4 gloves, e.g., 2, 3, 4, 5 or 6 gloves; however, it should be understood that the thickness of the glove material can affect the overall width of the pouch 100, such that more or fewer gloves may be accommodated. For example, the pouch can be configured to store 2, 3, 4, 5, 6, 7, 8 . . . up to 20 gloves. In one embodiment, the pouch 100 is configured to retain a number of gloves such that the width of the pouch 100 is about one-quarter of an inch. In this and other embodiments, a functional criticality can include limiting the number of gloves per pouch such that the overall width of the pouch does not preclude normal functioning of the fuel door D or fuel cap C.

In use, the pouch may first be filled with a desired number and type of glove, such as a sanitary use glove. The pouch can be filled by opening the main access 110 and inserting the gloves within the pouch, followed by closing, or resealing the main access 110. As described above, in other embodiments, the periphery of the front (101) and rear (102) sides can be sealed together, thereby enclosing a selected number of gloves. In such an embodiment, a main access 110 is alternatively unused.

Next, patch 125 can be used to adhere the rear surface 102 of pouch 100 onto door D so that the front surface 101 is facing outward as shown. Next, the door D can be closed, and the vehicle operated as usual. When it is time for the vehicle to be refueled, the user can open door D as usual, and remove or peel back access strip 116 to expose dispensing slot 115. One or more gloves 120 may be removed through the dispensing slot 115 which can be donned by the user. The user may then dispense fuel into their vehicle as usual, using the glove to protect him from germs existing on the fuel dispenser handle. If the access strip 116 is of the reusable type, it may be replaced over the dispensing slot 115 to keep the contents of the pouch 100 clean and protected.

In one embodiment, indicia may be printed on a surface of the pouch 100. The indicia may include advertising material or other indicia. In one exemplary embodiment, the indicia may include a QR (quick response) code printed on the inside surface of the rear side 102. The QR code may preferably be encoded for use by a mobile electronic device such as a cellular telephone to direct a user to a website or other digital portal whereby more gloves 120 or pouch(es) 100 may be ordered by a user.

In one embodiment, a colored glove (e.g., a pink or blue glove) may be inserted into the series of gloves 120 within the pouch 100. In particular, the colored glove can be placed within the series of gloves such that it serves as a reminder that the quantity of gloves is low and a new pouch 100 needs to be ordered.

In an example, gloves may be stacked and placed within the pouch 100 such that there exists a first glove, a number of intervening gloves, and a last glove in the stack. A colored glove may be placed, e.g., one- or two positions in the stack before the last glove would normally be extracted from the pouch.

In an alternative embodiment, a card or other piece of printable material may be inserted into the pouch 100, within the plurality of gloves 120, but near to the rear side 102, so that the card or printable material is exposed when the number of gloves remaining in the pouch is low, e.g., between 2-3 gloves remaining. The card or printable material may similarly include encoded—as in the case of a QR code—or unencoded indicia providing the user a digital avenue by which to order additional gloves 120 or pouch(es) 100 already pre-filled with gloves 120.

In an alternative embodiment, a bracket member (not shown in the drawings) configured to support a pouch 100 can be affixed to the inner surface of door D, thereby alleviating the need for patch 125. In such an embodiment, the bracket member can be small enough to be affixed onto door D without interfering with the action of the door or the fuel cap C. The bracket member can be configured to allow an empty pouch to be swapped for a new pouch (containing a full allotment of gloves) easily and quickly.

It should be understood that pouch 100 is exemplary and that other types of pouches and containers can be alternatively used for holding sanitary articles.

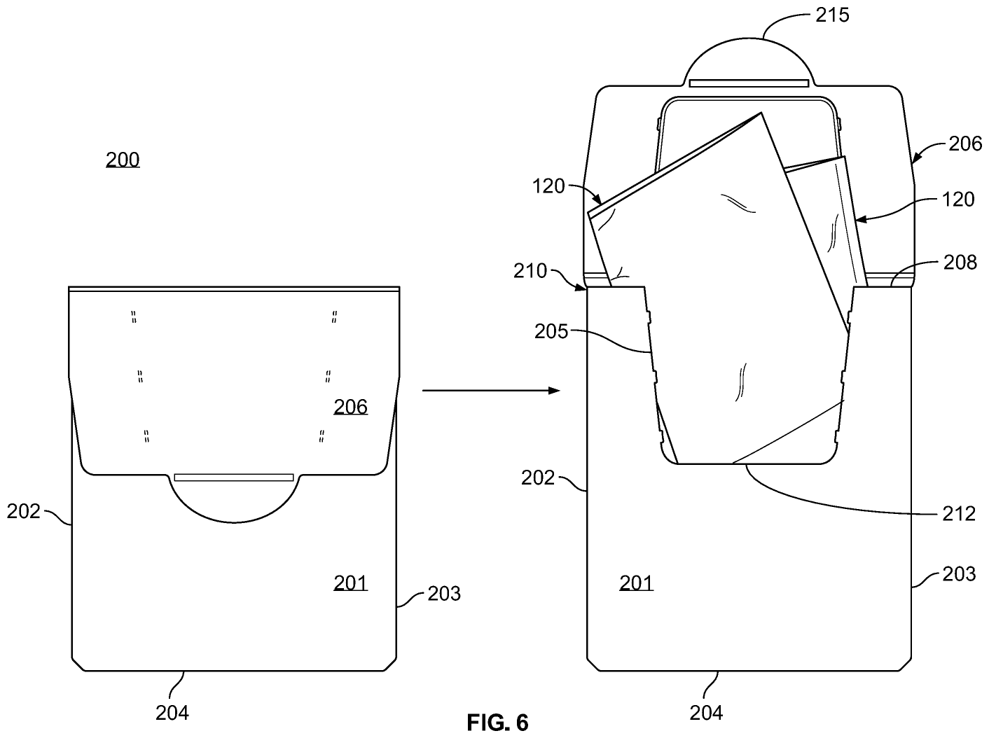

For example, referring to FIG. 6, pouch 200 includes a front side 201, a rear side 210 opposite the front side 201, a left side 202, a right side 203, and a bottom side 204. The pouch 200 further includes a U-shaped cut-out 205 on the front side 201. The rear side 210 includes a fold-over portion 206 extending therefrom configured to reversibly fold over a top portion 208 of the front side 201 and a tab member 215 of the fold-over portion 206 configured to tuck into a bottom portion 212 of the U-shaped cut-out 205. The pouch 200 further includes an adhesive disposed on the rear side 210 of the storage pouch. Gloves 120 are stored within the pouch 200, and the pouch 200 is configured to be adhered, by way of the adhesive, to an inner portion of a fuel door of a vehicle, such that when the fuel door is closed, the storage pouch is concealed from view.

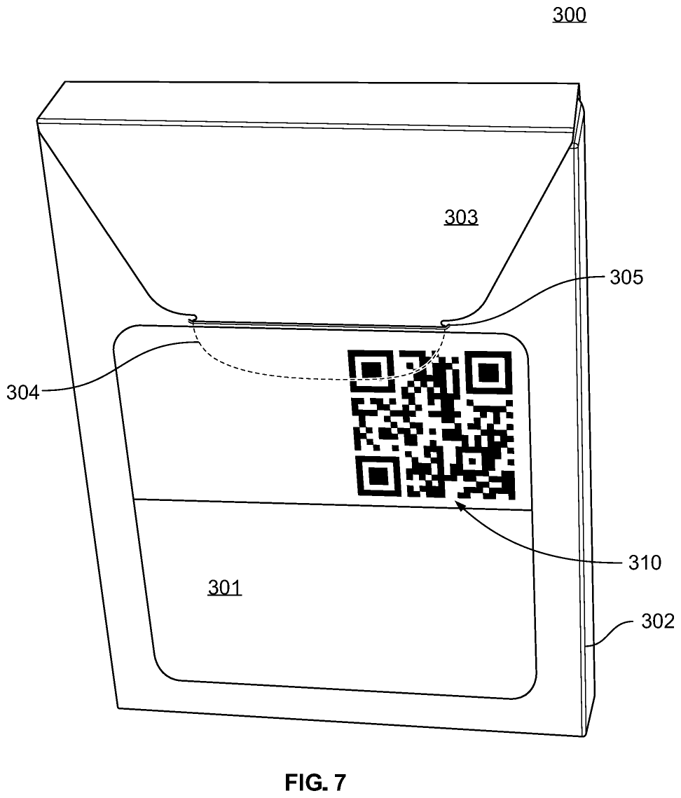

FIG. 7 illustrates a pouch 300 having a front side 301 and a rear side 302 opposite the front side, a fold-over portion 303 extending from the rear side 302, and a tab member 304 extending from the fold-over portion 303. The front side 301 includes a slot 305 for receiving the tab member 304, thereby providing a way to keep the fold-over portion 303 closed. An adhesive can be disposed on the rear side 302 to allow the pouch 300 to be placed inside a fuel door chamber and concealed from view. A QR code 310 provides an encoded hyperlink, accessible using, for example, a smart phone or other device capable of reading QR codes, that can lead a user to a website, ecommerce site, or other location on the Internet for ordering pouches.

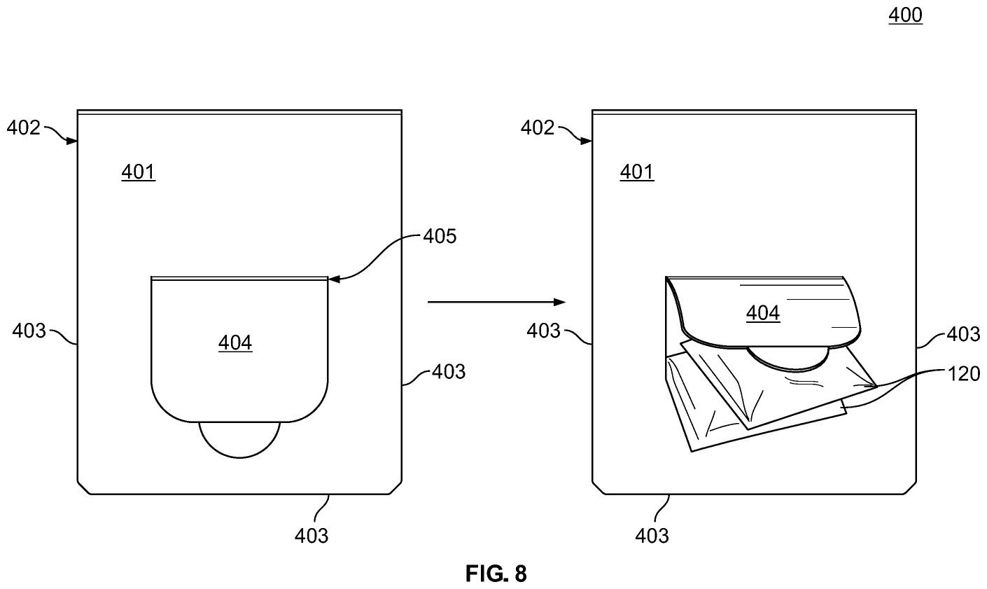

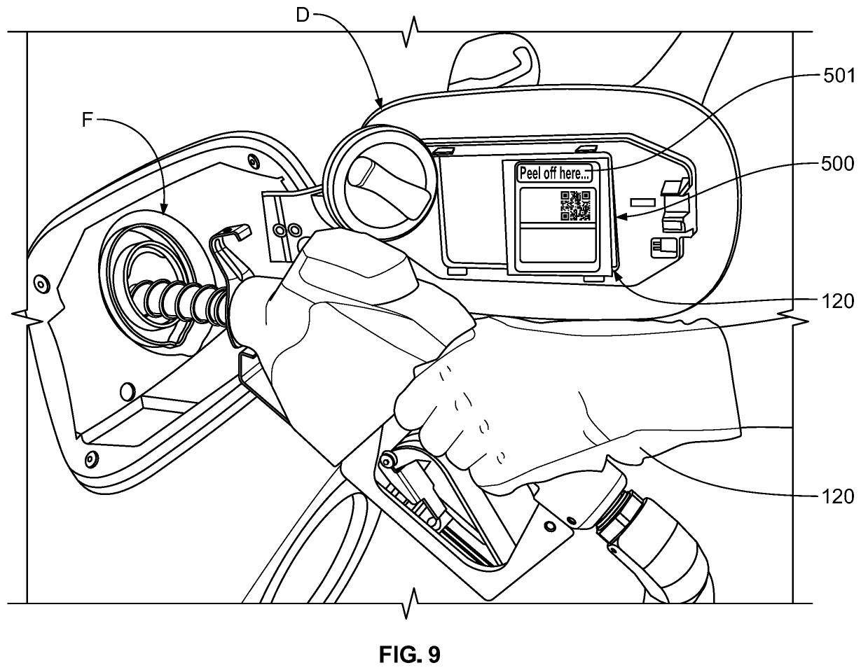

FIG. 8 illustrates a pouch 400 having front (401) and rear (402) sides. In this embodiment, the front (401) and rear (402) sides are joined at their respective circumferential edges 403, thereby forming a flat pouch. In this embodiment, an access door 404 capable of being folded up and down about a seam 405 is disposed on the front side 401, thereby allowing access to gloves 120 when needed.

FIG. 9 illustrates a pouch 500 adhered to the inner portion of a fuel door F. In this embodiment, the pouch 500 is formed of a plastic material and configured so as to retain a number of gloves 120. In this embodiment, the pouch includes a reversibly-sealable, fold-over top portion 501 that allows the pouch 500 to be opened and closed as desired to remove a glove 120 for use.

A number of illustrative embodiments have been described. Nevertheless, it will be understood that various modifications may be made without departing from the spirit and scope of the various embodiments presented herein. For example, while the present description has referenced a fuel door F of a petroleum-powered automobile, it should be understood that the concepts equally apply to other access doors such as those used on electric vehicles and the like. In certain embodiments, a pouch of the type described herein may be stored on other parts of an automobile, such as within a glove compartment box, on or under a dashboard, etc. Accordingly, other embodiments are within the scope of the following claims.

What is claimed is:

1. A pouch, concealable in a fuel door compartment of a vehicle for storing sanitary articles, comprising:
a storage pouch comprising at least a front side, a rear side opposite said front side, a left side, a right side and a bottom side;
a U-shaped cut-out on said front-side;
a closure slot disposed on said front side;
wherein said rear side comprises a fold-over portion and a tab member extending therefrom configured to reversibly fold over a portion of said front side and tuck into a bottom portion of said U-shaped cut-out;
an adhesive disposed on said rear side of said storage pouch; and
at least one sanitary article within said storage pouch;
wherein said storage pouch is configured to be adhered, by way of said adhesive, to an inner portion of a fuel door of a vehicle, such that when said fuel door is closed, said storage pouch is concealed from view.

2. The pouch of claim 1, further comprising a dispensing slot disposed on said front side of said storage pouch beneath said closure slot, said dispensing slot being configured to allow removal of at least one of said sanitary articles from within said storage pouch.

3. The pouch of claim 1, wherein said dispensing slot is covered by a reversibly-sealable cover.

4. The pouch of claim 1, wherein said sanitary article is a glove.

5. The pouch of claim 4, wherein said storage pouch is configured to retain between two and ten of said gloves.

6. The pouch of claim 1, further comprising indicia on said front side, said rear side, or both, said indicia providing an Internet hyperlink directed to an e-commerce platform.

7. The pouch of claim 6, wherein said indicia is a QR code.

8. The pouch of claim 1, wherein said adhesive is a double-sided tape.

9. The pouch of claim 1, wherein said adhesive comprises either a hook-side or loop-side of a hook-and-loop fastener.

10. The pouch of claim 1, wherein said left, bottom, and right sides of said rear side are joined to said left, bottom, and right sides of said front side, respectively.

11. The pouch of claim 1, further comprising:
a wall spanning between said left sides of said front and said rear sides, respectively;
a wall spanning between said bottom sides of said front and said rear sides, respectively; and
a wall spanning between said right sides of said front and said rear sides, respectively.

12. The pouch of claim 1, further comprising:
a plurality of said sanitary articles of a particular color disposed in said pouch in a stack; and
a single sanitary article of a different color, placed adjacent to said stack within said pouch.

13. The pouch of claim 12, wherein said single sanitary article of a different color is disposed within said pouch to indicate that said plurality of said sanitary articles has been removed.

14. The pouch of claim 1, wherein:
said sanitary articles are personal hygiene gloves arranged in a stack, said stack comprising a first glove in the stack, a last glove in the stack, and a plurality of intervening gloves disposed between said first and said last glove; and
wherein said first or said last glove is of a different color than the remainder of said gloves.

15. The pouch of claim 14, wherein said pouch further comprises an indicator disposed adjacent to said stack, said indicator indicating a level of gloves remaining in said pouch.

16. A method for preventing the transmission of disease from a fuel dispensing handle, comprising:
providing a pouch comprising a front side panel and a rear side panel joined together along a left, right and bottom perimeter edges of each of said front and said rear side panel, respectively;
wherein said pouch further comprises a reversibly-closable flap portion configured to allow said pouch to be opened and closed to access contents stored therein;
wherein said pouch is configured to be concealed within the fuel access compartment of an automobile;
placing at least one sanitary article within said pouch; and
placing an adhesive or an adhesive member on said rear side of said panel operable to hold said pouch in place within said fuel access compartment.

17. The method of claim 16, wherein said sanitary article is a glove.

18. The method of claim 17, further comprising:
placing a plurality of said gloves of a particular color in said pouch in a stacked configuration; and
placing a single glove of a different color adjacent to said stack within said pouch.

19. The method of claim 17, further comprising:
placing a plurality of said gloves of a particular color in said pouch in a stacked configuration; and
placing an indicator adjacent to said stack within said pouch, said indicator indicating a level of gloves remaining in said pouch.

20. The method of claim 17, further comprising placing between 3 and 8 gloves within said pouch.
